(19) United States
(12) Patent Application Publication
(10) Pub. No.: US 2006/0020061 A1
(43) Pub. Date: Jan. 26, 2006

(54) Stabilised block copolymers made from styrol monomers and diene monomers

(75) Inventors: Konrad Knoll, Ludwigshafen (DE); Ulrike Dardin, Laudenbach (DE); Philippe Desbois, Maikammer (DE); Konrad Mitulla, Ludwigshafen (DE); Paul Naegele, Otterstadt (DE)

Correspondence Address: CONNOLLY BOVE LODGE & HUTZ LLP, SUITE 800, 1990 M STREET NW, WASHINGTON, DC, 20036-3425, US

(73) Assignee: BASF AKTIENGESELLSCHAFT Patents, Trademarks and Licenses, Ludwigshafen (DE)

(21) Appl. No.: 10/525,088

(22) PCT Filed: Jul. 25, 2003
(86) PCT No.: PCT/EP03/08189

§ 371 Date: Feb. 23, 2005

(30) Foreign Application Priority Data
Aug. 29, 2002 (DE) 102 40 578.6

(51) Int. Cl. C08K 5/15

(52) U.S. Cl. 524/111

(57) ABSTRACT

The invention relates to thermoplastic moulded masses containing, a) at least one block copolymer (A), comprising, with relation to (A), a1) 50 to 90 wt. % of at least one styrol monomer, a2) 10 to 50 wt. % of at least one diene monomer, with the following as stabilisers, relative to the moulded mass, b) 0.001 to 0.18 wt. % of at least one benzofuranone derivative (B), c) 0.05 to 1 wt. % of at least one organic phosphite (C), and d) 0.1 to 0.3 wt. % of at least one stabiliser compound (D), selected from sterically hindered phenols and aromatic amines.

The invention relates to thermoplastic molding compositions comprising, where the total is 100% by weight,
a) at least one block copolymer A containing, in polymerized form, based on A,
   a1) from 50 to 90% by weight of at least one styrene monomer, and
   a2) from 10 to 50% by weight of at least one diene monomer, and, as stabilizers, based on the molding composition,
b) from 0.001 to 0.18% by weight of at least one benzofuranone derivative B,
c) from 0.05 to 1% by weight of at least one organic phosphite C, and
d) from 0.1 to 0.3% by weight of at least one stabilizer compound D selected from sterically hindered phenols and aromatic amines.

The invention further relates to a process for preparing the molding compositions, to the use of the molding compositions for producing moldings, foils, films, fibers, or foams, and also to the moldings, foils, films, fibers, or foams made from the molding compositions.

Aging phenomena in polymers can arise during their preparation or storage, or their processing to give moldings, or during the use of the moldings, and are generally the result of an oxidation reaction, e.g. atmospheric oxygen attacking the polymer an effect which is sometimes promoted by exposure to light (UV radiation). Polymers based on dienes, for example rubbers or rubber-containing thermoplastics, e.g. block copolymers containing blocks such as butadiene blocks and styrene blocks are particularly susceptible to aging. The oxidative aging impairs the optical and mechanical properties of the polymers (e.g. clouding of transparent polymers, yellowing; decrease in impact strength, elongation at break, and elasticity) and the polymers can become unusable.

To stabilize the polymers with respect to oxidative aging, use is usually made of antioxidants. A distinction is usually made, based on the different mechanism of action, between primary antioxidants, e.g. sterically hindered phenols and secondary aromatic amines, and secondary antioxidants, e.g. phosphites and thioethers. The classes of compound mentioned encompass numerous individual compounds of different structure, examples of references being R. Gachter, H. Müller: Plastic Additives Handbook, 4th edition, Hanser 1993, Reprint November 1996, pp. 1-128, and in particular here pages 40 to 48.

Use is often made of mixtures of various antioxidants—e.g. primary mixed with secondary antioxidants—thereby achieving synergistic effects where the effects of the individual components reinforce one another.

Styrene-butadiene block copolymers usually have continuous lamellar or cylindrical morphology (in contrast to the particulate morphology of impact-modified polystyrene or acrylonitrile-butadiene-styrene polymer), and are particularly susceptible to oxidative aging, since the rubber lamellae or rubber cylinders are exposed to high stresses, in particular during polymer processing. For example, during extrusion or during injection molding high shear forces arise and cause increased thermo-oxidative degradation of the polymer. This aging is noticeable particularly in gel formation by the polymer: the degradation reactions produce gels in the polymer, and these are noticeable in the molding in the form of undesirable gel particles associated with the formation of specks or with other surface defects.

U.S. Pat. No. 4,584,346 teaches styrene butadiene block copolymers comprising tris(nonylphenyl) phosphite (TNPP) having the formula II given at a later stage below and Irganox® 1076, a sterically hindered phenol having the formula IV given at a later stage below.

EP-A 263 524 discloses stabilizer mixtures made from a chromane derivative and from an organic phosphite.

EP-A 210 046 describes thermally stable butadiene polymers which comprise, inter alia, a sterically hindered phenol as stabilizer.

U.S. Pat. Nos. 5,516,920 and 5,428,162 disclose certain 3-arylbenzofuranones, including those of the formulae Ia and Ib given at a later stage below, and the use of these for stabilizing, inter alia, styrenebutadiene block copolymers. See Example 11 in column 41 of this U.S. Pat. No. 5,516,920 and column 41, line 42. This publication cites sterically hindered phenols in column 28 and phosphites at column 32 lines 40 to 58 as costabilizers.

GB-A 2 333 296 describes aging-susceptible elastomers, inter alia (on p. 24, line 1) styrene-butadiene block copolymers, with stabilization by from 0.2 to 10% by weight of benzofuranone compounds. Costabilizers mentioned include sterically hindered phenols on pages 24 to 27 and phosphites on page 31.

A disadvantage of these stabilizers mentioned is their inadequate effectiveness for some applications. In particular at high temperatures (e.g. above 200° C.), the stabilization often fails. In addition, large amounts are required of each of the—comparatively expensive—stabilizers. This makes the final product disadvantageously expensive.

Research Disclosure 39615, April 1997, pages 223 to 228, discloses the stabilization of hot-melt adhesives made from, inter alia, styrene-butadiene block copolymers by a mixture made from benzofuranone derivatives, organic phosphites, and sterically hindered phenols: for stabilization with respect to aging at 170° C. use is made of 0.8% by weight of Irganox® B225 and 0.2% by weight of HP 136. Irganox® B225 is a 1:1 mixture of Irganox® 1010, a sterically hindered phenol of the formula III given at a later stage below, and Irgafos® 168, tris(nonylphenyl) phosphite of the formula II. HP 136 is a benzofuranone derivative of the formula Ia given at a later stage below. Here again, relatively large amounts of the expensive additives are required, in particular 0.2% by weight of benzofuranone derivative and 0.4% by weight of sterically hindered phenol, and these are moreover sufficient only for stabilization at low processing temperatures (only 170° C.).

It is an object of the present invention to eliminate the disadvantages described. A particular object is to provide stabilized block copolymers made from styrene monomers and from diene monomers and having lower stabilizer contents than in the prior art, with resultant economic advantage. A further object is that, despite the reduced stabilizer contents, the block copolymers should have dependable stabilization with respect to aging, and to degradation during processing. The stabilization should remain effective even at high temperatures (above 200° C.) and on exposure to high shear forces. A particular object is that the block copolymers should have low gel content. A final object is to provide stabilized block copolymers with reduced gel formation at processing temperatures of from 200 to 280° C. when exposed to high shear forces (e.g. during extrusion).

We have found that this object is achieved by means of the thermoplastic molding compositions defined at the outset. In addition, a process for the preparation of the molding compositions has been found, as has the use of the molding compositions for producing moldings, foils, films, fibers, or foams, and also the moldings, foils, films, fibers, or foams made from the molding compositions.

Preferred embodiments of the invention are given in the subclaims.

None of the documents mentioned as prior art discloses styrene-butadiene block copolymers having a styrene content of at least 50% by weight and comprising the small inventive amounts of the stabilizers.

Component A

Component A is present in the molding compositions at a proportion which gives a total of 100% by weight with the other components of the molding composition.

A is a block copolymer containing, in polymerized form, based on A,
a1) from 50 to 90% by weight, preferably from 60 to 85% by weight, and in particular from 70 to 85% by weight, of at least one styrene monomer, and
a2) from 10 to 50% by weight, preferably from 15 to 40% by weight, and in particular from 15 to 30% by weight, of at least one diene monomer.

The styrene monomers which may be used, other than styrene or in a mixture with styrene, are vinylaromatic monomers having substitution with C₁₋₂₀-hydrocarbon radicals on the aromatic ring and/or on the C═C double bond. It is preferable to use styrene, α-methylstyrene, p-methylstyrene, ethylstyrene, tert-butylstyrene, vinyltoluene, 1,2-diphenylethylene, 1,1-diphenylethylene, or a mixture of these. It is particularly preferable to use styrene.

Examples of diene monomers which may be used are 1,3-butadiene, 2,3-dimethylbutadiene, 1,3-pentadiene, 1,3-hexadiene, isoprene, and piperylene. 1,3-Butadiene and isoprene are preferred, in particular 1,3-butadiene (abbreviated below to butadiene).

It is advantageous for the monomers and other starting materials, e.g. solvents, to be used in typical process purity, i.e. using a method known per se to remove impurities, such as residual moisture, polar substances, oxygen, immediately prior to polymerization.

In addition to the styrene monomers and diene monomers it is also possible to make concomitant use of other comonomers. The proportion of the comonomers is preferably from 0 to 50% by weight, particularly preferably from 0 to 30% by weight, and in particular from 0 to 15% by weight, based on the total amount of the monomers used.

Examples of suitable comonomers are acrylates, in particular C₁₋₁₂-alkyl acrylates, such as n-butyl acrylate or 2-ethylhexyl acrylate, and the corresponding methacrylates, in particular C₁₋₁₂-alkyl methacrylates, eg. methyl methacrylate (MMA). Other suitable comonomers are the monomers mentioned under M1 to M10 in DE-A 196 33 626, on p. 3, lines 5-50. That publication is expressly incorporated herein by way of reference.

The styrene monomer preferably used is styrene and the diene monomer preferably used is butadiene, i.e. the block copolymer A is preferably a styrene-butadiene block copolymer.

The block copolymers—which are known per se—are generally prepared by anionic polymerization in a manner known per se.

The initiators usually used for the anionic polymerization are mono-, bi-, or multifunctional alkali metal alkyl compounds, multifunctional alkali metal aryl compounds, or multifunctional alkali metal aralkyl compounds. It is advantageous to use organolithium compounds, such as ethyl-, propyl-, isopropyl-, n-butyl-, sec-butyl-, tert-butyl-, phenyl-, diphenylhexyl-, hexamethylenedi-, butadienyl-, isoprenyl, or polystyryllithium, or the multifunctional compounds 1,4-dilithiobutane, 1,4-dilithio-2-butene, or 1,4-dilithiobenzene. The amount of organyl alkali metal compound needed depends on the desired molecular weight, the nature and amount of the other organyl metal compounds used, and also on the polymerization temperature. It is generally in the range from 1 ppm(w) to 2% by weight, preferably from 100 ppm(w) to 1% by weight, in particular from 1000 to 5000 ppm(w), based on the total amount of monomer.

The polymerization may be carried out in the absence (bulk polymerization) or in the presence (solution polymerization) of a solvent. Solution polymerization which is preferred—advantageously takes place in an aliphatic, isocyclic, or aromatic hydrocarbon or hydrocarbon mixture, such as benzene, toluene, ethylbenzene, xylene, cumene, pentane, heptane, octane, cyclohexane, or methylcyclohexane. Preference is given to solvent with a boiling point above 95° C. Toluene is particularly preferably used.

To control the reaction rate, additives which reduce polymerization rate may be added if required, these being known as retarders, as described in WO 98/07766. However, retarders are not essential. Examples of suitable retarders are organyl metal compounds of an element of the periodic table. For example, use may be made of the organyl compounds of the elements Be, Mg, Ca, Sr, Ba, B, Al, Ga, In, Tl, Zn, Cd, Hg. The organyl compounds of magnesium and of aluminum are preferably used.

Organyl compounds are the organometallic compounds of the elements mentioned having at least one metal-carbon δ-bond, in particular the alkyl compounds or aryl compounds. The organyl metal compounds may also contain, on the metal, hydrogen, halogen, or organic radicals bonded via heteroatoms, examples of organic radicals being alcoholates and phenolates. Examples of ways of obtaining the latter are complete or partial hydrolysis, alcoholysis, or aminolysis. It is also possible to use mixtures of various organyl metal compounds.

Suitable organyl magnesium compounds are those of the formula R₂Mg, where the radicals R are, independently of one another, hydrogen, halogen, C₁-C₂₀-alkyl, or C₆-C₂₀-aryl. It is preferable to use dialkylmagnesium compounds, in particular the ethyl-, propyl-, butyl-, hexyl-, or octyl compounds which are commercially available. Particular preference is given to hydrocarbon-soluble (n-butyl) (sec-butyl)magnesium or (n-butyl) (n-octyl) magnesium.

Organyl aluminum compounds which may be used are those of the formula R₃Al, where the radicals R are, independently of one another, hydrogen, halogen, C₁-C₂₀-alkyl, or C₆-C₂₀-aryl. Preferred organyl aluminum compounds are the trialkylaluminum compounds, such as triethylaluminum, triisobutylaluminum (TIBA), tri-n-butylaluminum, triisopropylaluminum, tri-n-hexylaluminum.

Particular preference is given to the use of triisobutylaluminum. Other organyl aluminum compounds which may be used are those which are produced by partial or complete hydrolysis, alcoholysis, aminolysis, or oxidation of alkyl- or arylaluminum compounds. Examples are diethylaluminum ethoxide, diisobutylaluminum ethoxide, diisobutyl(2,6-di-tert-butyl-4-methylphenoxy)aluminum (CAS No. 56252-56-3), methylaluminoxane, isobutylated methylaluminoxane, isobutylaluminoxane, tetraisobutyldialuminoxane, and bis(diisobutyl)aluminum oxide.

It is also possible to use various magnesium compounds or aluminum compounds together.

The anionic polymerization is particularly preferably carried out in the presence of a trialkylaluminum compound and/or dialkylmagnesium compound.

The molar ratios of the lithium compounds and of the magnesium compound or aluminum compound may vary within relatively wide ranges. They depend mainly on the desired molecular weight, on the desired polymerization rate, and on the polymerization temperature, and also on the nature and amount of the monomers. The molar ratio of magnesium or aluminum to alkali metal is advantageously in the range from 0.2:1 to 5:1. If use is made of magnesium compounds and aluminum compounds together, the molar ratio of the total of magnesium and aluminum to lithium during the polymerization is in the range from 0.2:1 to 5:1.

Once the polymerization has ended, the living polymer chains can be kept using a chain terminator. Suitable chain terminators are protonic substances or Lewis acids, e.g. water, alcohols, aliphatic and aromatic carboxylic acids, and also inorganic acids, such as carbonic acid or boric acid.

Examples of the styrene-butadiene block copolymers A are S—B linear two-block copolymers and S—B—S or B—S—B three-block copolymers (S=styrene block, B=butadiene block), as are obtained via anionic polymerization using processes known per se. The block structure is substantially the result of initial anionic polymerization of styrene alone, producing a styrene block. Once the styrene monomers have been consumed, the monomer is changed by adding monomeric butadiene and anionically polymerizing this to give a butadiene block (this being known as sequential polymerization). The resultant S—B two-block polymer may be polymerized to give a S—B—S three-block polymer via another change of monomer to styrene, if desired. The same principle applies to B—S—B three-block copolymers.

In the case of the three-block copolymers, the two styrene blocks may be of equal size (equal molecular weight, i.e. symmetrical S₁—B—S₁ structure) or may differ in size (different molecular weight, i.e. a symmetrical S₁—B—S₂ structure). The same principle applies to the two butadiene blocks of the B—S—B block copolymers. Of course, S—S—B or S₁—S₂—B, or S—B—B, or S—B₁—B₂ block sequences are also possible. The indices above represent the block sizes (block lengths or molecular weights). The block sizes depend, for example, on the amounts of monomer used and the polymerization conditions.

There may also be B/S blocks in place of the “soft” elastomeric butadiene blocks B or in addition to the blocks B. The B/S blocks are likewise soft, and contain butadiene and styrene, for example with random distribution or in the form of a tapered structure (tapered=gradient from styrene-rich to styrene-poor or vice versa). If the block copolymer contains two or more B/S blocks, the absolute amounts, and the relative proportions, of styrene and butadiene in each of the B/S blocks may be identical or different (giving different blocks (B/S)₁, (B/S)₂, etc.). The generalized term “mixed” blocks is used for the B/S blocks—irrespective of whether their structure is random or tapered or of some other type.

Four- and polyblock copolymers are also suitable as styrene-butadiene block copolymers.

The block copolymers mentioned may have a linear structure (described above). However, branched and star-shaped structures are preferred. Branched block copolymers are obtained in a known manner, e.g. by graft reactions of polymeric “branches” onto a main polymer chain.

An example of a method for obtaining star-shaped block copolymers is reaction of the living anionic chain ends with an at least bifunctional coupling agent. These coupling agents are described by way of example in U.S. Pat Nos. 3,985,830, 3,280,084, 3,637,554, and 4,091,053. Preference is given to epoxidized glycerides (e.g. epoxidized linseed oil or soy oil), silicon halides, such as SiCl₄, or else divinylbenzene, or polyfunctional aldehydes, ketones, esters, anhydrides, or epoxides. Preference is also given to carbonates, such as diethyl carbonate or ethylene carbonate (1,3-dioxolan-2-one). Other compounds specifically suitable for dimerization are dichlorodialkylsilanes, dialdehydes, such as terephthalaldehyde, and esters, such as ethyl formate or ethyl acetate.

Via coupling of identical or different polymer chains, it is possible to prepare symmetrical or asymmetrical star structures, meaning that each of the limbs of the star may be identical or different, and in particular contain different blocks S, B, B/S, or different block sequences. Further details concerning star-shaped block copolymers can be found by way of example in WO-A 00/58380.

By way of example, the following embodiments 1) to 4) of styrene-butadiene block copolymers are used as component A:

1) an asymmetrically star-shaped branched styrene-butadiene block copolymer of the structure i 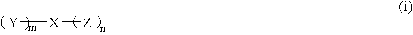
where Y is a block copolymer section composed of at least one polystyrene block of molecular weight from 3000 to 230 000 and at least one polybutadiene block of molecular weight from 2000 to 30 000, and
Z is a block copolymer section composed of at least one polystyrene block of molecular weight from 2000 to 60 000 and at least one polybutadiene block of molecular weight from 2000 to 30 000,
where the total molecular weight of Y is from 50 000 to 250 000 and the total molecular weight of Z is from 5000 to 75 000,
the block transitions are sharp or tapered,
X is the radical of a coupling agent, and
the total number of arms of the star m+n is from 3 to 15,
with the proviso that m≦n.

2) a symmetrically or asymmetrically star-shaped branched styrene-butadiene block copolymer having styrene blocks and mixed B/S blocks made from butadiene and styrene. It is preferable for at least one arm of the star to have a block sequence S₁—(B/S)— and for at least one other arm of the star to have the block sequence S₂—(B/S)—, or for at least one arm to have the block sequence S₁—(B/S)—S₃—, and for at least one arm to have the block sequence S₂—(B/S)—S₃—.

Other preferred embodiments 2) are block copolymers with structures where at least one arm of the star has the block sequence S₁—(B/S)₁—(B/S)₂—, and at least one arm of the star has the block sequence S₂—(B/S)₁—(B/S)₂—, or where at least one arm of the star has the block sequence S₁—(B/S)₁—(B/S)₂—S₃—, and at least one arm of the star has the block sequence S₂—(B/S)₁—(B/S)₂—S₃—. In principle here, two or more styrene blocks S₁—S₂ in succession may also replace any outer (terminal) styrene block S, giving block sequences S₁—S₂—(B/S)₁—(B/S)₂— or S₁—S₂—(B/S)₁—(B/S)₂—S₃—.

Very particularly preferred embodiments 2) are block copolymers of the following structures ii and iii 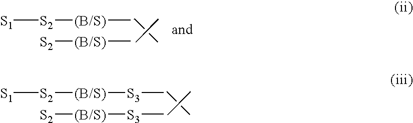
where X is the radical of the coupling agent. There may also be a block sequence (B/S)₁—(B/S)₂ here in place of the B/S block. Very particular preference is also given to the structures I and II mentioned in Examples 6 to 8 on page 8 in WO-A 00/58380, and to the structures Ib, IIb, and III mentioned in Examples 12 to 19 on page 12 of WO-A 00/58380.

3) a linear styrene-butadiene block copolymer having at least two styrene blocks and at least one polybutadiene block, where the molecular weight data mentioned above for embodiment 1) apply to the polystyrene blocks and polybutadiene blocks, respectively.

4) a linear styrene-butadiene block copolymer having at least two styrene blocks S and at least one mixed block B/S made from butadiene and styrene. The two styrene blocks are preferably outer (terminal), and the styrene block lengths here may be identical, S₁—(B/S)—S₁ structure, or non-identical, S₁—(B/S)—S₂ structure. There may also be n mixed blocks (B/S)_{1 to n} instead of a mixed block B/S between the styrene blocks. In the case of, for example, three mixed blocks the structure is therefore S₁—(B/S)₁—(B/S)₂—(B/S)₃—S₁ or S₁—(B/S)l-(B/S)₂—(B/S)₃—S₂.

A possible embodiment 4) is a block copolymer whose structure is S₁—(B/S)—S₁, where it is particularly preferable for each of the two styrene blocks S₁ to make up about 16% by weight of the block copolymer and for the mixed B/S block to make up about 68% by weight of the block copolymer. The butadiene content of this block copolymer is very particularly preferably about 35% by weight. This polymer has the property profile of thermoplastic elastomers (TPE).

The skilled worker can find further details on the embodiments described under 2) and 4) in WO-A 00/58380, in particular on pages 3 to 4 of that publication.

The block copolymer particularly preferably has a star-shaped structure, for example corresponding to the above embodiments 1) and 2).

The terms styrene and butadiene used above for monomers are used by way of example and include other vinylaromatics and dienes, respectively.

The thermoplastic molding compositions of the invention are generally transparent, or at least opaque (translucent). Due to the proportion of at least 50% by weight of styrene monomer in component A, they are usually tough and stiff, unlike styrene-butadiene block copolymers having less than 50% by weight of styrene, which are generally elastomeric or soft.

Component B

The proportion of component B present in the molding compositions is from 0.001 to 0.18% by weight, preferably from 0.01 to 0.15% by weight, in particular from 0.02 to 0.1% by weight. The proportion of B is very particularly preferably from 0.05 to 0.1% by weight, in particular from 0.06 to 0.08% by weight, based on the molding composition.

Component B is a benzofuranone derivative. A benzofuranone derivative is any of the compounds which contain the structural element benzofuranone.

As benzofuranone derivative B it is preferable to use benzofuran-2-one compounds, particularly preferably 3-arylbenzofuran-2-ones.

The compounds described in U.S. Pat. No. 5,516,920 are particularly suitable, and in that publication see also the individual compounds Nos. 101-121 and 201-212 in columns 43-54.

The suitable compounds are those described in U.S. Pat. No. 5,428,162, and in that publication see also the individual compounds Nos. 101-144 in columns 33-50.

Other suitable compounds are those mentioned in GB-A 2 333 296.

The benzofuranone derivatives B are prepared in a manner known per se, by reacting phenol compounds with derivatives of mandelic acid. Their preparation is described in the three abovementioned publications.

The benzofuranone derivative B is very particularly preferably a compound of the formula Ia 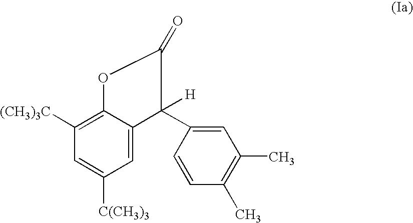
or of the formula Ib 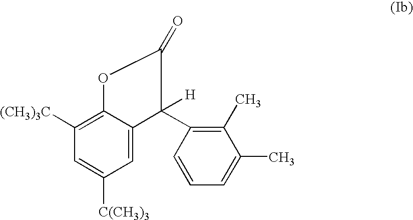
or a mixture of these.

The compounds Ia and Ib are isomers and differ in the position of the methyl groups on the phenyl radical.

If use is made of a mixture of the compounds Ia and Ib, the ratio Ia:Ib by weight is preferably from 75:25 to 95:5, in particular from 80:20 to 90:10, particularly preferably about 85:15.

The benzofuranone derivative of the formula Ia or Ib is obtainable as in Example 11 in columns 41-42 of the abovementioned U.S. Pat. No. 5,516,920, and commercially as HP 136 from Ciba Specialty Chemicals. HP 136 is a mixture composed of 85 parts by weight of compound Ia and 15 parts by weight of compound Ib.

Component C

The proportion present in the molding compositions of component C is from 0.05 to 1% by weight, preferably from 0.1 to 0.8% by weight, in particular from 0.2 to 0.5% by weight. The proportion of C is very particularly preferably about 0.4% by weight, based on the molding composition.

Component C is an organic phosphite. Examples of suitable organic phosphites are 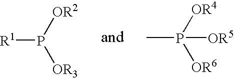
with R¹═H or organic radical, R² to R⁶=identical or different organic radicals. Phosphites include phosphonites.

Examples of particularly suitable phosphites and phosphonites are triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)pentaerythritol diphosphite, diisodecyl pentaerythritol diphosphite, bis(2,4-di-tert-butyl-6-methylphenyl)pentaerythritol diphosphite, bis(2,4,6-tris(tert-butylphenyl))pentaerythritol diphosphite, tristearyl sorbitol triphosphite, tetrakis(2,4-di-tert-butylphenyl)4,4′-biphenylenediphosphonite, 6-isooctyloxy-2,4,8,10-tetra-tert-butyl-12-H-dibenz[d,g]-1,3,2-dioxaphosphocine, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyldibenz[d,g]-1,3,2-dioxaphosphocine, 2,2′,2″-nitrilotriethyl tris(3,3′,5,5′-tetra-tert-butyl-1,1′-biphenyl-2,2′-diylphosphite), 2-ethylhexyl (3,3′,5,5′-tetra-tert-butyl-1,1′-biphenyl-2,2′-diyl)phosphite, and 5-butyl-5-ethyl-2-(2,4,6-tri-tert-butylphenoxy)-1,3,2-dioxaphosphirane.

The phosphites C are known and commercially available. They are prepared in a manner known per se.

It is particularly preferable to use triaryl phosphites, such as triphenyl phosphite, tris(2,4-di-tert-butylphenyl)phosphite, and tris(nonylphenyl)phosphite (TNPP).

The organic phosphite C is very particularly preferably a compound of the formula II 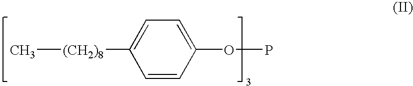
i.e. TNPP.

The compound II, TNPP, is available commercially, for example as Irgafos® TNPP from Ciba Specialty Chemicals.

Component D

Component D is present in the molding compositions at a proportion of from 0.1 to 0.3% by weight, preferably from 0.12 to 0.25% by weight, in particular from 0.13 to 0.22% by weight. The proportion of D is very particularly preferably from 0.14 to 0.21% by weight, based on the molding composition.

Component D is a stabilizer compound D selected from sterically hindered phenols and aromatic amines. Stabilizer compound D is therefore a primary antioxidant, probably acting as a scavenger for oxygen radicals.

Examples of particularly suitable sterically hindered phenols are the following groups of compound 1 to 12:

1. Alkylated monophenols, e.g. 2,6-di-tert-butyl-4-methylphenol, 2-tert-butyl-4,6-dimethylphenol, 2,6-di-tertbutyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, and nonylphenols where the side chains are linear or branched, e.g. 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol, and mixtures of these.

2. Alkylthiomethylphenols, e.g. 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol.

3. Hydroquinones and alkylated hydroquinones, e.g. 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl)adipate.

4. Hydroxylated thiodiphenyl ethers, e.g. 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

5. Alkylidenebisphenols, e.g. 2,2′-methylenebis(6-tert-butyl-4-methylphenol), 2,2′-methylenebis(6-tert-butyl-4-ethylphenol), 2,2-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[α-methylbenzyl)-4-nonylphenol), 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethyleneglycol bis[3,3-bis(3′-tertbutyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-Bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.

6. Hydroxybenzylated malonates, e.g. dioctadecyl 2,2-bis(3,5-di-tert-butyl-2-hydroxybenzyl)malonate, dioctadecyl 2-(3-tert-butyl-4-hydroxy-5-methylbenzyl)malonate, didodecylmercaptoethyl 2,2-bis(3,5-di-tert-butyl-4-hydroxybenzyl)malonate, bis(4-(1,1,3,3-tetramethylbutyl)phenyl]2,2-bis(3,5-di-tert-butyl-4-hydroxybenzyl)malonate.

7. Aromatic hydroxybenzyl compounds, e.g. 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

8. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

9. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

10. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

11. Esters of 3,5-di-tert-butyl-4-hydroxyphenylacetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

12. Amides of β-(3,5-di-tert-butyl-4-hydroxyphenyl)propionic acid, e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide.

Examples of particularly suitable (in particular secondary) aromatic amines are N,N′-diisopropyl-p-phenylenediamine, N,N′-disec-butyl-p-phenylenediamine, N,N′-bis(1,4-dimethylpentyl)-p-phenylendiamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N-phenyl-p-phenylenediamine, N-(1,3-dimethylbutyl)-N-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-disec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, e.g. p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-di-methylbutyl)phenylamine, tert-octylated N-phenyl-1-naphthylamine, a mixture of mono- and dialkylated tert-butyl-tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4-H-1,4-benzothiazine, phenothiazine, a mixture of mono- and dialkylated tert-butyl-tert-octylphenothiazines, a mixture of mono- and dialkylated tert-octylphenothiazines, N-allylphenothiazine, N,N,N,N′-tetraphenyl-1,4-diaminobut-2-ene, N,N-bis(2,2,6,6-tetramethylpiperid-4-yl)hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

Benzylamines, such as tris(3,5-di-tert-butyl-4-hydroxybenzyl)amine, and acylaminophenols, such as 4-hdroxylauranilide, 4-hydroxystearanilide, or octyl N-(3,5-di-tert-butyl-4-hydroxyphenyl)carbamate, are likewise particularly suitable.

Other particularly suitable stabilizer compounds D include sterically hindered phenols and aromatic amines which contain a triazine structure unit. Examples of these triazine compounds are 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoky)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazin, 1,3,5-tris(3,5-dicyclohexyl-4-hydroxybenzyl) isocyanurate.

The stabilizer compounds D are known and commercially available, or can be prepared in a manner known per se.

Particularly preferred stabilizer compounds D used are sterically hindered phenols, in particular esters of β-(3,5-di-tert-butyl-4-hydroxyphenyl)propionic acid, see above under 8.

The stabilizer compound D is very particularly preferably a sterically hindered phenol of the formula III 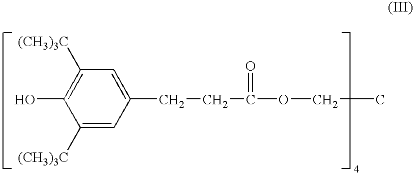
or of the formula IV 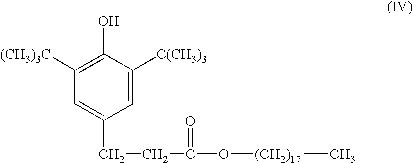
or a mixture of these.

Compound II is pentaerythritol tetrakis[3-(3,5-di-tert-butyl-4-hydroxyphenyl)propionate], and compound IV is n-octadecyl 3-(3,5-di-tert-butyl-4-hydroxyphenyl)propionate.

If compound III is used as component D, the proportion in the molding composition is preferably from 0.13 to 0.17% by weight, in particular from 0.14 to 0.16% by weight, and particularly preferably about 0.15% by weight.

If compound IV is used as component D, the proportion in the molding composition is preferably from 0.18 to 0.22% by weight, in particular from 0.10 to 0.21% by weight, and particularly preferably about 0.2% by weight.

Compound III is commercially available, e.g. as Irganox® 1010, and compound IV is commercially available, e.g. as Irganox® 1076 (both from Ciba Specialty Chemicals).

In particular, compound III alone is used as component D.

Instead of a single benzofuranone derivative B it is, of course, also possible to use two or more benzofuranone derivatives B₁, B₂, etc., and in that case the proportions for B apply to the total of all of the n components B₁ to Bₙ.

The above principle also applies to component C, organic phosphites, and component D, stabilizer compounds (sterically hindered phenols and/or aromatic amines).

In the molding compositions of the invention, the ratio of the amount of stabilizer compound D to that of the benzofuranone derivative B is preferably from B 3:1 to 1:1, in particular from 2.5:1 to 1:1.

It is likely that the benzofuranone derivative B acts as a scavenger for carbon radicals involved in the process of aging of the block copolymer. The organic phosphite C probably acts as a scavenger for oxygen O₂, which is another concomitant cause of aging. The stabilizer compound D appears to act as a scavenger of oxygen radicals, which are also involved in polymer aging.

Optional Other Components

The molding compositions of the invention may comprise other components in addition to the components A to D.

There are in particular conventional processing aids and additives other than the abovementioned components A to D, e.g. lubricants or mold-release agents, colorants, e.g. pigments or dyes, flame retardants, antioxidants, light stabilizers, fibrous or pulverulent fillers, or-reinforcing agents, or antistats, or else other additives, or a mixture of these.

Examples of suitable lubricants and mold-release agents are stearic acids, stearyl alcohol, stearic esters, stearamides, metal stearates, Montan waxes, and similar substances based on polyethylene or polypropylene.

Examples of pigments are titanium dioxide, phthalocyanines, ultramarine blue, iron oxide, and carbon black, and also the class of organic pigments. Dyes are any of the dyes which can be used for transparent, semitransparent, or non-transparent coloring of polymers. These dyes are known to the skilled worker.

Examples of flame retardants which can be used are the halogen-containing or phosphorus-containing compounds known to the skilled worker, magnesium hydroxide, and other commonly used compounds, or a mixture of these.

Suitable other antioxidants are compounds other than the abovementioned components B to D.

Examples of suitable light stabilizers are various substituted resorcinols, salicylates, benzotriazoles, benzophenones, HALS (Hindered Amine Light Stabilizers), for example those commercially available as Tinuvin®.

Examples which may be mentioned of fibrous or pulverulent fillers are carbon fibers or glass fibers in the form of glass fabrics, glass mats, or glass silk rovings, chopped glass, or glass beads, and also wollastonite, particularly preferably glass fibers. When glass fibers are used, these may have been provided a size and with a coupling agent to improve compatibility with the components of the blend. The glass fibers incorporated may either be in the form of short glass fibers or else in the form of continuous-filament strands (rovings).

Suitable particulate fillers are carbon black, amorphous silica, magnesium carbonate, chalk, powdered quartz, mica, bentonites, talc, feldspar, or in particular calcium silicates, such as wollastonite, and kaolin.

Examples of suitable antistats are amine derivatives, such as N,N-bis(hydroxyalkyl)alkylamines or -alkyleneamines, polyethylene glycol esters, and glycerol mono- and distearates, and also mixtures of these.

The amounts used of each of the additives are those which are conventional, and no further information need therefore be given in that connection.

Preparation of the Molding Compositions

The molding compositions of the invention may be prepared by mixing processes known per se, for example with melting in an extruder, Banbury mixer, or kneader, or on a roll mill or calender, at temperatures from 180 to 280° C. The components may also, however, be mixed “cold” without melting, the mixture composed of powder or pellets not being melted and homogenized until it is processed.

Individual components may also be premixed, or some or all of the components may be mixed in solution, the solvent then being removed, e.g. in vented extruders.

Any known method may be used to add the components B, C, and D to the block copolymer A. For example, they may be added in pure form directly during the post-treatment of the reaction mixture obtained during the preparation of the block copolymer to give moldings., foils, etc. However, it is also possible for one or more of the components B to D to be premixed with the polymer, either as solid or in solution, whereupon the solution is freed from solvent in the usual way, e.g. by devolatilization. It is also possible for the components B to D to be metered in as masterbatch (concentrate made from polymer and large amounts of B, C, and/or D).

The molding compositions are generally prepared in a manner which does not render them basic.

The molding compositions are preferably neutral to slightly acidic, as a result of suitable measures during their preparation. It is likely that the action of the stabilizers (components B to D) improves under neutral to slightly acidic conditions.

Neutral to slightly acidic means here-that the pH of the molding compositions is from 3 to 7, particularly preferably from 5 to 6. Preparation encompasses the entire process from the monomers to the finished molding composition, e.g. the polymerization of the monomers to give the block copolymer A, the addition of components B to D, the addition and removal of polymerization auxiliaries, and the blending and further processing to give the final molding composition. The preparation therefore in particular also encompasses the post-treatment of the block copolymer to give the molding composition, and the further processing of the molding composition to give the final product.

The general method of rendering the molding composition neutral to slightly acidic is that the block copolymer A, which is post-treated in the usual way to give the molding composition, is adjusted to an appropriate pH. To this end, it is preferable to add CO₂ and water to the molding composition during its preparation (including the post-treatment to give the molding composition).

The invention therefore also provides a process for preparing the molding compositions as claimed in any of claims 1 to 8, where the molding composition is rendered neutral to slightly acidic by addition of CO₂ and water during its preparation.

In one preferred embodiment, CO₂ and water are added after the polymerization of the block copolymer A: block copolymer A is prepared from the styrene monomers and diene monomers in a polymerization reactor, and in one example the CO₂ and water are metered in to the reaction mixture when the reaction is substantially complete, while the mixture is in the reactor or when the mixture is discharged from the reactor (i.e. after the polymerization).

Together with CO₂/water, it is also possible, if desired, to add one or more of the components B, C, and D.

In one particularly preferred embodiment, CO₂ and/or water are again metered into the molding composition at a later stage of the preparation, in particular at a later stage of post-treatment. For example, CO₂ and/or water may be metered in during removal of the solvent used concomitantly during the polymerization of the block copolymer, or during blending of the components A to D. The metering-in of more material can in particular be advantageous when all or some of the first addition of CO₂ and/or water has been lost through the post-treatment.

It has proven to be advantageous to design the preparation of the molding compositions of the invention via addition of CO₂ and water in a manner known per se such that the conditions prevailing during the entire post-treatment are not basic but neutral to slightly acidic.

For example,-prior to removal of the-solvent-used during the polymerization it is advantageous to establish a CO₂ pressure higher than the vapor pressure of the solvent to be removed, so that even during the solvent-separation process there is sufficient CO₂ present in the reaction mixture to keep the mixture in the neutral to slightly acidic range.

CO₂ and water are generally added together. However, separate addition is also possible. It is also possible for water or CO₂ alone to be metered in during the further addition, depending on whether water or CO₂ is lost during the post-treatment.

In another embodiment, also preferred, CO₂ and water are added during further processing of the molding composition obtained during the post-treatment, i.e. during subsequent treatment of the molding composition. This subsequent treatment produces the final product, the final molding composition.

To this end, the molding composition (generally after solidification or cooling) is conditioned in the presence of water and CO₂. Conditioning is storage for a certain time at a defined temperature, mostly above room temperature.

Conditioning at from 20 to 60° C., in particular from 30 to 50° C., preferably about 40° C., for from 10 to 200 hours, in particular from 40 to 100 hours, preferably from 60 to 80 hours, have been found to be advantageous.

During the conditioning, the molding composition is preferably in comminuted form, for example in the form of pellets, powder, or chips.

The conditioning can be carried out in a simple manner by charging the molding composition and water to a closed stirred vessel, heating the reactor to the conditioning temperature, and metering in CO₂. It is advantageous to stir the polymer/water mixture. To increase the CO₂ content of water, conditioning may be carried out at a superatmospheric pressure of CO₂.

A particularly simple way of conditioning consists in storing the molding composition, for example in the form of pellets, in a drying cabinet at the conditioning temperature in the presence of water (vapor) and CO₂. The CO₂ used here may advantageously be solid CO₂ (dry ice), and the water may advantageously be introduced into the drying cabinet via an open vessel (dish, glass beaker) filled with water, or a water-saturated fabric (wet cloth).

It is also possible to combine the two abovementioned embodiments for addition of CO₂ and water, i.e. add CO₂ and water to the reaction mixture and also subject the pelletized molding composition to subsequent treatment (conditioning) with CO₂ and water.

It is also possible to use other—preferably aqueous—acids or buffer systems instead of CO₂ and water, in particular with weak organic or inorganic acids or salts of these.

Irrespective of the acidifier, the pH of the acidified water is preferably from 3 to 7, in particular from 5 to 6.

Molding compositions prepared as described above with addition of CO₂ and water generally have a paler intrinsic color, in particular reduced yellow tinge. Due to the conditioning, the molding composition pellets or molding composition powder, and the moldings, foils, films, fibers, or foams produced therefrom are colorless and have no yellow tinge.

The thermoplastic molding compositions of the invention may be processed by the known methods of thermoplastics processing, for example by extrusion, injection molding, calendering, blow molding, or sintering.

The molding compositions may be used to produce moldings, foils, films, fibers, or foams. This use is likewise provided by the invention. Films are (thin) foils and also surface coatings.

For reasons including their good printability, the films and foils of the invention are in particular suitable for packaging purposes, e.g. for food packaging. They are also suitable as shrink foils. These shrink foils are used in the packaging of small components, for example, or, after print-finishing, as labeling or closure sealing for containers (drinks bottles, jars, dishes, etc.). The films and foils of the invention are also suitable as thermoforming films, stretch films, and cling films. The self-adhesive cling films in particular are used as freshness-retaining films for foods.

The moldings, foils, films, fibers, and foams mentioned are also provided by the invention.

Due to the low stabilizer contents, the molding compositions of the invention have economic advantages over the molding compositions of the prior art. Despite the small amounts of stabilizers, they have reliable protection from aging and degradation reactions during processing. This also applies in particular at high temperatures and under high shear forces.

The gel content of the molding compositions is low. It should be emphasized that even at processing temperatures of from 200 to 280° C. and under high shear (e.g. due to extrusion) the molding compositions exhibit a markedly lower level of gel formation.

In particular, the stabilizer mixture (components B to D) using the inventive proportions of amounts of components B, C, and D is more effective than the—known prior-art—use of a single component B or C or D.

The smaller amounts of stabilizer also mean that the level of global migration is lower. Global migration is the entirety of all of the constituents which can migrate, and should be minimized for food packaging, for example.

This makes the block copolymers of the invention particularly suitable for food and drink application, e.g. as food packaging, food tray, drinks cup, drinks bottles, cutlery, plates, freshness-retaining film, etc.

### EXAMPLES

1. Preparation of Compositions Comprising a Star-Shaped Styrene-Butadiene Block Copolymer

The starting materials were purified and dried, where necessary, using aluminum oxide beads.
sec-BuLi: is a 12% strength by weight solution of sec-butyllithium in cyclohexane, ready-to-use solution from Chemmetall,
polystyrene: is a rubber-free polystyrene prepared by free-radical polymerization, with a number-average molecular weight Mₙ of 96 000 and a weight-average molecular weight M_{w} of 272 000, determined using gel permeation chromatography and polystyrene calibration standard (PS standard kit from Polymer Laboratories). The commercial product Polystyrene 158K from BASF was used.
Edenol: is an epoxidized linseed oil used as coupling agent; the commercial product Edenol® B 316 from Henkel was used.
Acrawax: is a commercially available fatty amide; the commercial product Acrawax® from Lonza was used.
white oil: Winok® 70 mineral oil from Wintershall was used.

The following stabilizers were used:
B: Benzofuranone derivative mixture made from 85 parts by weight of the compound of the abovementioned formula Ia and 15 parts by weight of the abovementioned formula Ib. The commercial product HP 136 from Ciba Specialty Chemicals was used.
C: Organic phosphite of the abovementioned formula II, i.e. TNPP. A conventional commercial product was used.
D: Sterically hindered phenol of the abovementioned formula III. The commercial product Irganox® 1010 from Ciba Specialty Chemicals was used.

Star-shaped styrene-butadiene block copolymers of the abovementioned structure ii 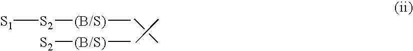
were obtained by sequential anionic polymerization of styrene and butadiene in cyclohexane as solvent, followed by coupling. To this end, 509 kg of cyclohexane and 78 kg of styrene (for the block S₁) formed an initial charge in a nitrogen-flushed 1500 l stirred reactor, with stirring and were heated to 40° C., and titrated to completion with sec-BuLi solution to remove impurities. To prepare the S₁ block, the polymerization was then initiated by adding 600 g of sec-BuLi solution, and the reaction mixture was cooled to 60° C. once the maximum temperature had been reached. To prepare the S₂ block, 2100 g of sec-BuLi solution was used for initiation and 47 kg of styrene were added, and the mixture was controlled to 50° C. once the maximum temperature had been reached. To prepare the B/S block, 52 kg of butadiene and 26 kg of styrene were then added in the form of separate beads. Once the maximum temperature had been reached, the reaction was allowed to continue for 10 min. Finally, to couple the resultant block copolymers 540 ml of Edenol were added, the mixture was controlled to 55° C., and the reaction was allowed to continue for 10 min.

1000 ml of water were then added to the resultant polymer solution, with rapid stirring, and after 5 min a further 1000 ml of water were added, and after another 5 min a further 1000 ml of water were added. CO₂ gas was then passed into the solution for 20 min, rendering it slightly acidic.

A mixture of 1700 g of stabilizer C and 1000 ml of cyclohexane was then added to this acidic polymer solution. A solution of 470 g of Acrawax in 3000 ml of cyclohexane was also added, as finally were 4300 g of white oil. Stirring was continued for 10 min.

Portions of the resultant polymer solution (one portion for each example) were finally freed from the cyclohexane solvent in a ZSK 40 twin-screw vented extruder from Werner+Pfleiderer, Stuttgart, and at the same time treated with the other stabilizers B and D. The following were added at 200° C. to the extruder:
100 kg/h of the polymer solution (corresponding to 29 kg/h of block copolymer),
3.92 kg/h of polystyrene, and
amounts of the stabilizers B and D such that the resultant molding composition comprised the proportions of B and D given in the table.

The molding composition was extruded and, after cooling, pelletized.

Each specimen of pellets obtained was conditioned (subsequently treated) with CO₂ and water. For this, 100 g of pellets were stored for 72 hours at 40° C. in a closed drying cabinet with CO₂ dry ice and a water-saturated cloth. This gave colorless, transparent pellets.

2. Testing of the Molding Compositions for Resistance to Aging

To determine the resistance of the resultant stabilized block copolymers to aging, rheographic studies were carried out on the pellets obtained. The Rheograph 2000 from Göttfert, Buchen, Germany was used.

Comments on the principle underlying the test:

The method for rheography is similar to that for measuring melt volume rate MVR or melt volume index MVI in that the polymer is melted in a heated container which has an outlet die. A piston which advances at a constant rate (i.e. not a superimposed weight as in the case of MVR or MVI) is used to press the melt through the die. The melt pressure is measured at constant piston advance rate. During the test period, thermo-oxidative aging of the polymer causes crosslinking of the rubber phase. The result is a rise in melt viscosity and therefore also in the melt pressure.

The action of a stabilizer can be seen in that there is (some degree of) time delay in the melt pressure rise, when comparison is made with the unstabilized polymer. The pressure difference between start (time t=t₀) and end (t=t_{E}) of the test period, known as the crosslinking pressure _{C}, serves as a measure of aging resistance, and therefore as a measure of stabilization effectiveness. p_{V}=p(t_{E})−p(t₀).

The smaller the pressure difference, the smaller the rise which occurred in melt pressure or melt viscosity, i.e. the lower the level of rubber phase crosslinking, i.e. the smaller the degree of polymer aging which occurred. The smaller the crosslinking pressure p_{V}, therefore, the more effective the stabilization.

The melt temperature during rheography was 270° C.

The table below gives the composition and results. The proportion of block copolymer A here is the balancing percentage to give 100% by weight.

TABLE
Composition and results (c for comparison)

| | Composition [% by weight]¹⁾ | | | Crosslinking |
|---|---|---|---|---|
| | Benzofuranone | Phosphite | Hin. phenol | pressure p_{V} |
| Example | B | C | D | [bar] |
| 1c | 0.08 | 0.4 | — | 17 |
| 2c | 0.1 | 0.4 | — | 12 |
| 3c | 0.12 | 0.4 | — | 10 |
| 4c | 0.14 | 0.4 | — | 8 |
| 5c | 0.16 | 0.4 | — | 9 |
| 6 | 0.1 | 0.4 | 0.3 | 10 |
| 7 | 0.1 | 0.4 | 0.2 | 10 |
| 8 | 0.1 | 0.4 | 0.15 | 12 |
| 9 | 0.1 | 0.4 | 0.1 | 7 |
| 10 | 0.07 | 0.4 | 0.2 | 9 |
| 11 | 0.07 | 0.4 | 0.15 | 5 |
| 12 | 0.07 | 0.4 | 0.1 | 6 |
| 13 | 0.05 | 0.4 | 0.2 | 7 |

¹⁾The balancing proportion required for 100% by weight is block copolymer A

The table shows that the block copolymers have effective resistance to aging (discernible from low crosslinking pressure p_{V}) specifically when the amounts of each of the stabilizers B, C, and D are within the low ranges of the invention.

1-11. (canceled)

12. A process for the prepration of thermoplastic molding compositions comprising, where the total is 100% by weight,
a) at least one block copolymer A containing, in polymerized form, based on A,
a1) from 50 to 90% by weight of at least one styrene monomer, and
a2) from 10 to 50% by weight of at least one diene monomer,
and, as stabilizers, based on the molding composition,
b) from 0.001 to 0.18% by weight of at least one benzofuranone derivative B,
c) from 0.05 to 1% by weight of at least one organic phosphite C, and
d) from 0.1 to 0.3% by weight of at least one stabilizer compound D selected from sterically hindered phenols and aromatic amines, which comprises setting a pH of the molding composition at from 3 to 7 via addition of CO₂ and water during the preparation process.

13. A prcoess as claimed in claim 1, wherein the block copolymer A is a styrene-butadiene block copolymer.

14. A process as claimed in claim 1, wherein the block copolymer A has a star-shaped structure.

15. A process as claimed in claim 1, wherein the benzofuranone derivative B is a compound of the formula Ia 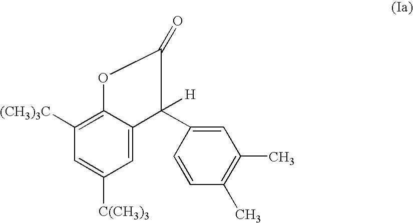
or of the formula Ib 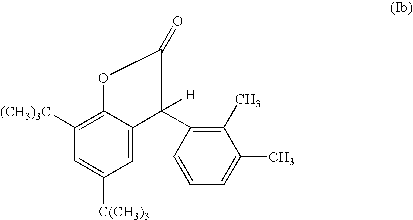
or a mixture of these.

16. A process as claimed in claim 1, wherein the organic phosphite C is a compound of the formula

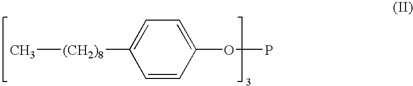

17. A process as claimed in claim 1, wherein the stabilizer compound D is a sterically hindered phenol of the formula III 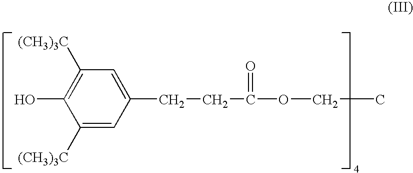
or of the formula IV 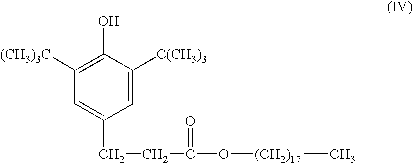
or a mixture of these.

18. A process as claimed in claim 1, wherein the ratio of the amount of stabilizer compound D to that of benzofuranone derivative B is from 3:1 to 1:1 parts by weight.
